(19) United States
(12) Patent Application Publication
(10) Pub. No.: US 2010/0146980 A1
(43) Pub. Date: Jun. 17, 2010

(54) MASKING ARRANGEMENT FOR A GAS TURBINE ENGINE

(75) Inventors: Linda Ström, Trollhattan (SE); Hans Martensson, Trollhattan (SE); Jonas Larsson, Goteborg (SE); Lena Andersson, Lilla Edet (SE)

Correspondence Address: WRB-IP LLP, 1217 KING STREET, ALEXANDRIA, VA, 22314, US

(73) Assignee: VOLVO AERO CORPORATION, TROLLHATTAN (SE)

(21) Appl. No.: 12/600,262

(22) PCT Filed: May 22, 2007
(86) PCT No.: PCT/SE07/00498

§ 371 Date: Nov. 15, 2009

(51) Int. Cl. F02K 1/82

(52) U.S. Cl. 60/770; 60/39.5; 239/265.11

(57) ABSTRACT

A masking arrangement for a gas turbine engine includes a plurality of annular elements arranged overlapping one another when these are viewed in an axial direction so as to mask at least a substantial portion of any interior hot and rotating gas turbine engine part at an aft end of the gas turbine engine from rear view when the masking arrangement is applied downstream the interior part in the gas turbine engine.

### BACKGROUND AND SUMMARY

The invention relates to a masking arrangement for a gas turbine engine, in particular for masking off an exhaust duct of the gas turbine engine in order to avoid detection and especially to reduce the infra-red and/or radar signature of said gas turbine engine. This involves reducing the infra-red radiation of any rotating and hot parts of the gas turbine, so that they are not visible through an exhaust duct extending downstream from the turbine, and preferably to eliminate or reduce radar reflecting surfaces in said exhaust duct.

It has long been realized that it may be quite desirable under certain circumstances to minimize visibility of the turbine of a gas turbine engine or, in other words, to minimize direct radiation from the hot pans of the engine out the exhaust pipe or jet nozzle of such an engine.

One reason for this is that rotating and hot parts of the gas turbine used in jet engines can be observed from a rear view through the exhaust nozzle exit. This information is used by military detection systems to locate and identify the flying aircraft. If the rotating parts can not be observed by radar, and the hot parts can not be observed by infra-red (IR) detection apparatus the flying aircraft can operate more invisibly. Consequently, a reduced signature has the effect that a threat must be positioned closer to the aircraft in order to detect it. In other words, a reduced signature increases the chances of surviving an attack.

U.S. Pat. No. 5,233,827 describes an example of an arrangement for minimizing visibility of the turbine through the exhaust duct or, conversely, radiation from the turbine, by the use of two relatively staggered rows of reversely cambered turning vanes in the annular outlet from the turbine. The projected area of the vanes covers the entire area of the exhaust duct so that the parts ahead of it are no longer directly visible through the exhaust duct.

One problem with this solution is that it requires a relatively large number of radial vanes to be mounted between the engine core and the outer wall of the exhaust duct. This adds to the complexity, weight and cost of manufacturing the engine and may also result in an undesirable weakening of the structure of the exhaust duct. In addition, the positioning of the staggered vanes may also produce a small but undesirable tangential force inducing a torque on the engine about its main axis.

It is desirable to provide an improved masking arrangement for reducing the IR signature by minimizing radiation from the hot parts of the turbine in the exhaust section of a jet engine, which arrangement overcomes at least one of the above problems. It is also desirable to effect such reduction in radiation with a minimum of interference with the efficiency of the thrust produced by the engine. It is also desirable to provide an improved arrangement for reducing the radar signature of the exhaust section of a jet engine.

According to an aspect of the present invention, a masking arrangement comprises at least one annular element, which is adapted to mask at least a substantial portion of an interior gas turbine engine part at an aft end of the gas turbine engine from rear view when the masking arrangement is applied downstream said interior part in the gas turbine engine.

In this context, the term “annular” should be interpreted to include an annular element having a continuous or a partial extent. For instance, an annular element may comprise a circular ring or a segment thereof.

One single annular element may suffice to mask off a substantial part of the hot and rotating inner parts of the turbine from rear view. Such a single annular element should be designed with such an axial (and also radial) extension depending on how large portion of the inner turbine parts that is to be masked in the individual case.

According to a preferred embodiment, the arrangement comprises a plurality of annular elements arranged overlapping one another when these are viewed in an axial direction so as to mask said at least substantial portion of the interior gas turbine engine part at the aft end of the gas turbine engine from rear view when the masking arrangement is applied downstream said interior part in the gas turbine engine.

Each annular element preferably has a main extension component in an axial direction of the arrangement. Further, the annular element is at least partially inclined with regard to the axial direction in order to achieve said overlapping relationship. Preferably, the annular elements form vanes. Especially, the annular elements have a cross-section in the shape of an airfoil.

According to one example, the gas turbine engine comprises a turbine with an outlet and exhaust nozzle extending from the outlet and terminating in a discharge port for the turbine exhaust. The discharge port normally has a circular cross section shape, but may alternatively have an annular, oval, square, rectangular, or any other suitable shape. The outlet comprises an outer wall and an inner wall arranged about a central longitudinal axis through the engine. More specifically, the inner wall may form part of a center cone and the outer wall may form part of a casing. The inner and outer walls are preferably arranged concentrically and symmetrically, but may as an alternative be arranged, asymmetrically, offset or in any suitable position relative to each other. According to one embodiment, the masking arrangement comprises a plurality of annular elements arranged concentrically between the inner and outer walls of the outlet and the annular elements are arranged to be overlapping one another when these are viewed in an axial direction so as to mask the rotating and/or hot parts of the engine, such as the turbine from rear view through the discharge port. For example, the plurality of annular elements may preferably, but not necessarily, comprise a predetermined number of circular vanes. The annular elements may, however, be given any suitable shape to conform to the shape of the outlet or discharge port.

Thus, the annular elements are arranged in a partially overlapping relationship when viewed in an axial direction of the arrangement (i.e in the longitudinal direction of the gas turbine engine). In the above case, the effect is that any rotating and hot parts of the gas turbine engine are not visible past the overlapping annular elements when looking upstream through the discharge port of an exhaust duct. Preferably, the annular elements are arranged in such a manner that any rotating and hot parts of the engine are masked seen from any angle from the rear.

The number of annular elements is dependent on the radial distance between the inner and outer walls, the length of each vane in the axial direction and the angle relative to the longitudinal axis of the engine. These variables may be selected to give the desired masking function of the invention. Further, the radar signature may be reduced by positioning the annular elements at a smaller distance from each other than the wave length of the radar waves. Consequently, the number of annular elements is preferably smaller than ten, especially smaller than eight, and advantageously smaller than six. According to a preferred embodiment, there are four annular elements.

The annular elements may be supported by one or a plurality of supports. Preferably, a plurality of radially extending supports are arranged in a circumferentially spaced manner. According to one example, the supports extend between stationary walls of the gas turbine engine aft end, preferably between the inner and outer walls of the outlet. Alternatively, the supports are attached to solely the outer wall, solely to the inner wall or to any upstream or downstream component. The supports may be mounted in a radial plane at right angles to or at an angle to the longitudinal axis of the engine. In the latter case the supports are preferably mounted at a divergent angle relative to the longitudinal axis, that is outwards and rearwards relative to the said axis.

According to one embodiment, at least two of said annular elements are at least partially axially displaced relative to one another, wherein two adjacent vanes are overlapping each other seen in a radial direction but displaced a short distance in the axial direction. In this example, when starting from the innermost vane, each consecutive vane is preferably, but not necessarily, displaced in a rearward direction. The overlap may be constant or variable. This arrangement is inherent for vanes mounted on supports mounted at an angle to the longitudinal axis, but can also be achieved for vanes mounted on radial supports extending at right angles relative to the said axis.

The annular elements may be arranged to be angled relative to the longitudinal axis in each plane coinciding with said longitudinal axis. Preferably the vanes may be arranged to be angled towards the longitudinal axis to the rear of the masking arrangement.

Annular elements in the form of circular vane airfoils may also be used for controlling the exhaust flow. The annular outlet of an exhaust nozzle may be provided with a flow control device to control the flow over the centre cone and in a diffusive exhaust nozzle. According to the invention; the circular vane airfoils may be used to substitute or complement such a flow control device.

There may be a plurality of components with different tasks between the turbine and the exhaust exit in an aircraft engine, in particular in a military jet engine with or without an afterburner. In the exhaust section there may be three main components, that is, a de-swirling device, a fuel injection system, and a flame holder. The axial extent of the exhaust casing nozzle must be adapted to be sufficiently long to support all these components. At the same time it is desirable to keep the engines as short as possible to save weight and thereby fuel consumption. The invention provides a solution to these contradictory requirements.

According to one example, the radial supports may be arranged as de-swirling vanes downstream of a final turbine stage. In order to achieve this, the radial supports can be located at a suitable angle relative to the direction of flow, whereby the radial supports have been rotated a predetermined angle about a longitudinal axis passing through the radial support and intersecting the central axis of the engine. Preferably the radial supports are provided with an airfoil cross-section that will correct the swirling flow of the exhaust after leaving the final turbine stage.

According to a further example, the radial supports may be provided with fuel injection nozzles arranged as a fuel injector system for an afterburner arrangement. A fuel conduit may extend from a radially outer end of the support through a separate conduit or a suitable hollow section in the radial support to exit at one or more radially spaced fuel injection nozzles along a rear section of said support. Alternatively, the fuel injection nozzles may be arranged as fuel spray bars between adjacent radial supports. This example may also use radial supports arranged as de-swirling vanes downstream of a final turbine stage, as described above. Similarly, air nozzles may be arranged in the radial supports and/or the annular elements for air distribution.

According to a further example, rear sections of the radial supports may be provided with flame holders for an afterburner arrangement This example may also use radial supports provided with fuel injection nozzles arranged as a fuel injector system for an afterburner arrangement and/or radial supports arranged as de-swirling vanes downstream of a final turbine stage. When the radial supports are arranged to be provided with both fuel injection nozzles and flame holders for an afterburner arrangement, the fuel injection nozzles must be arranged upstream of the flame holders. For instance, the fuel injection nozzles may be placed in a flow controlling surface of a radial support with an airfoil cross-section, while the flame holder may be attached to or integrated in a rear section thereof. Alternatively, the fuel injection nozzles may be placed in fuel spray bars in circumferential positions between the radial supports, upstream of the flame holders attached to or integrated in a rear section of said radial supports. In both cases the fuel injection nozzles should be located in radial positions between adjacent annular elements. In this way an optimum fuel spray can be achieved by distributing the fuel both in radial and circumferential directions. Further, the overlapping annular elements may be configured for a flame holding function.

According to a further example, the radial supports and the annular elements may be provided with cooling channels for reducing the temperature of the masking arrangement. The cooling channels may comprise separate conduits or may use existing internal hollow sections through at least the radial support. Alternatively, the cooling channels may extend in a similar way through the annular elements to further reduce the temperature of the masking arrangement. The coolant used for this purpose may be taken from an existing source of coolant for the gas turbine engine. Alternatively, fuel supplied to the injection nozzles in the afterburner arrangement may be used for cooling purposes, at least for cooling the radial supports. The method of cooling and the type of coolant used is dependent on the component parts present in each of the examples described above.

The number of radial support is dependent on the radial distance between the inner and outer walls, the length of each vane in the axial direction and the desired function of the support. For instance, radial, supports arranged as de-swirling vanes must be designed to carry the aerodynamic load of the exhaust gas leaving the final turbine stage. If the radial supports are provided with integrated fuel injectors and/or flame holders for an afterburner system, then the chosen function may dictate the number of supports. Further, the radial supports may be configured to carry structural loads and/or be hollow in order to house service components, such as pipes for oil or air.

Consequently, the number of supports may preferably, but not necessarily, be selected between one and twenty and especially between three and ten supports depending on the size of the engine and the function or combination of functions to be performed by the supports.

At least the annular elements may be formed in a radar absorbing material or coated with a radar absorbing material. Any other components visible through the exhaust duct may also be provided with such a coating. This will assist in reducing the radar signature of the gas turbine engine. In addition, reducing the number of component parts located downstream of the annular elements will assist in reducing the radar signature even further. This can be achieved by integrating the fuel injectors and/or the flame holders for the afterburner system into the radial supports for the annular elements.

The examples or individual modifications of such examples, as described above, may be combined when possible in order to achieve improved properties relating to the reduction of the IR and radar signature of the gas turbine engine.

The invention further relates to a gas turbine engine provided with a masking arrangement as described above.

According to the examples described above, the invention relates to a masking arrangement to be placed after the last rotating stage of a turbine in the rear part of the engine. The masking arrangement aims to provide full or partial blocking of turbine rotating parts from a rear view and comprises a number of annular rings, preferably aerodynamically shaped airfoils, supported by a number of radial struts. A primary function of the invention is to reduce the radar and IR visibility of the exhaust section of the gas turbine engine.

By combining or co-locating one or more of the components normally present in the exhaust section of the engine, the masking arrangement may be configured:
to provide full radial distribution of radar absorbing material in rear part of the engine
to complement or substitute de-swirling outlet guide vanes
to complement or substitute afterburner fuel injection system
to complement or substitute afterburner flame holder
to complement or substitute air injection mixing device
to complement or substitute flow control device over the centre cone and in a diffusive exhaust nozzle.

The invention also has a number of secondary functions, relating to aerodynamics, combustion and weight.

With respect to aerodynamics, the masking arrangement according to the invention may be adapted to provide de-swirling (turning), diffusion control and/or modification of aerodynamic loads. The shape and angle of the annular vanes can be used for separation control, especially for controlling the flow over the centre cone, which may improve the engine performance and acoustics. The annular vanes can be used for flow control by adjusting the direction and distribution of flow in a diffuser before flame holder. This may be used for stabilizing the flow by adjusting the exhaust flow to provide optimal flow characteristics for fuel injection and flame stabilization in the afterburner arrangement.

With respect to combustion, the masking arrangement according to the invention can enhance mixing by creating suitable flow patterns by means of the annular vanes and the radial supports. This may be used for reducing temperature gradients of the exhaust gas, and to increase mixing fuel and air injected during operation of the afterburner. By using the annular vanes for flow separation control it is possible to reduce the risk of combustion at wrong locations. Hot spots created during such combustion may often be found in areas where flow separation occurs. By combining a fuel injection system with fuel spray bars, the radial supports and/or the annular elements the fuel spray is optimally distributed in both radial and circumferential directions.

Air needed for combustion in the afterburner stage may be introduced by distribution of ambient air in both radial and circumferential directions by combining a conventional air injection system with the masking arrangement.

Combining a fuel injection system and/or air supply system with the masking arrangement according to the invention may also improve the acoustic properties of the engine. By distribution of fuel and/or air in optimum radial and circumferential directions, it is possible to reduce the risk of having areas with large temperature gradients coinciding with areas that are fuel rich.

The masking arrangement according to the invention can also be used for saving weight. By careful design of masking arrangement, removing the de-swirling vanes after the last rotor stage of turbine, and by co-locating components relating to flow control and/or the afterburner arrangement, a shortening of one or more of the exhaust case, exhaust nozzle and central core is possible. This will result in a shorter and more compact gas turbine engine.

The invention may also have a positive effect on cost and product life of the gas turbine engine. Optimum air and fuel supply may be achieved by combining the masking arrangement with the air and/or fuel supply system. This may in turn reduce liner cracking because of rumble and screech, that is, fatal combustion instabilities of different frequencies.

### BRIEF DESCRIPTION OF DRAWINGS

The invention will be described in detail with reference to the attached figures. It is to be understood that the drawings are designed solely for the purpose of illustration and are not intended as a definition of the limits of the invention, for which reference should be made to the appended claims. It should be further understood that the drawings are not necessarily drawn to scale and that, unless otherwise indicated, they are merely intended to schematically illustrate the structures and procedures described herein.

FIG. 1 shows a schematic cross-section of a gas turbine engine according to the invention;

FIG. 2 shows a rear view of the masking arrangement indicated in FIG. 1;

FIG. 3 shows a cross-section through the circular vanes parallel to a radial support;

FIG. 4A shows an exhaust section according to a first example of the invention;

FIG. 4B shows an exhaust section according to a second example of the invention;

FIG. 4C shows an exhaust section according to a third example of the invention;

FIG. 4D shows a modification of the example in FIG. 4C;

FIG. 4E shows an exhaust section according to a fourth example of the invention; and

FIG. 4F shows a modification of the example in FIG. 4E.

### DETAILED DESCRIPTION

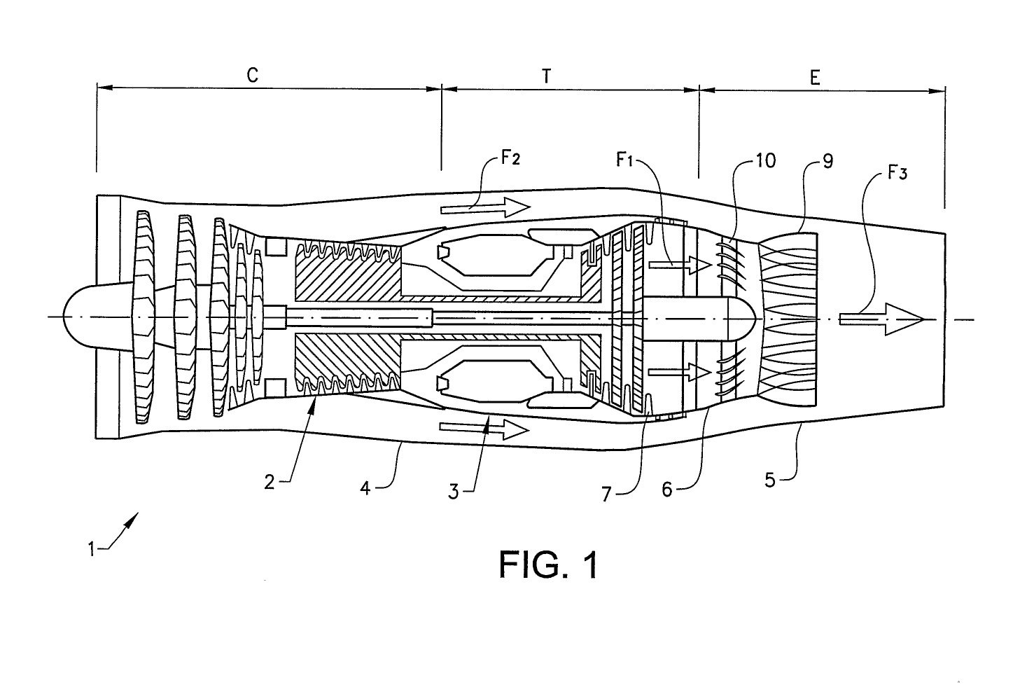

FIG. 1 shows a schematic cross-section of a gas turbine engine 1 according to the invention. The turbofan engine 1 comprises a compressor and fan section C, a combustor section and turbine section T and an exhaust section E. The compressor and fan section C is enclosed by a compressor shroud 2, while the combustor section and turbine section T is enclosed by a turbine shroud 3. The turbine shroud 3 is arranged to contain a central core flow F-i. A fan flow F2 that passes through a first part of the fan section is arranged to bypass the combustor and turbine section T by flowing through a fan flow shroud 4 surrounding the turbine shroud 3. The core flow Fi and fan flow F2 is passed into an exhaust shroud 5, where they are mixed and exit the engine as an exhaust flow F3. The exhaust section E is enclosed by an exhaust case 5. At the end of the turbine section T the core flow Fi is contained by an outer wall formed by an inner exhaust nozzle 6 attached to the end of the turbine shroud 3. The exhaust gas leaves a final turbine stage 7 to pass into the inner exhaust nozzle 6 and through a masking arrangement 10 attached between the outer wall of the inner exhaust nozzle 6 and an inner wall formed by a fixed central cone 8. The inner exhaust nozzle 6 and the fixed central cone 8 are terminated a predetermined distance into the surrounding exhaust shroud 5 of the exhaust section E.

The exhaust section E can comprise an optional flow mixer unit 9 (dashed lines) for mixing the core flow Fi and fan flow F2. Such a flow mixer unit 9 can comprise a fixed multi-lobed flow mixer attached to the end of the inner exhaust nozzle 6 around the central cone 8.

The numbering used in describing the general outline of the gas turbine engine in FIG. 1 will be adhered to in the subsequent text, unless otherwise indicated.

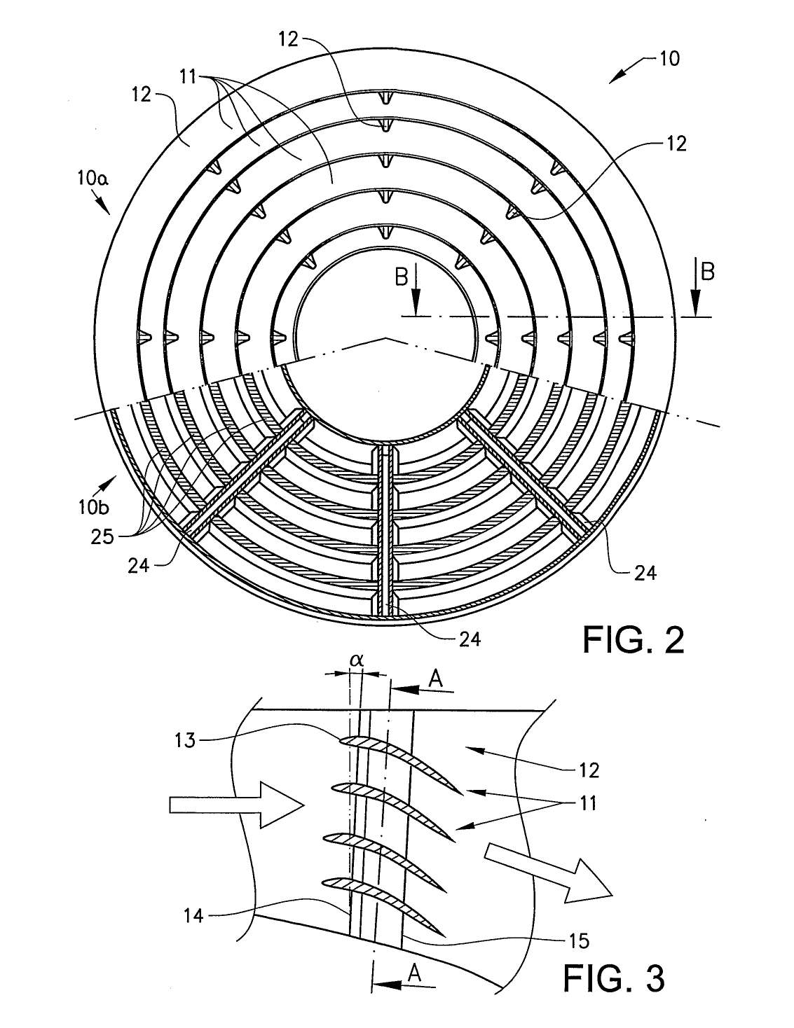

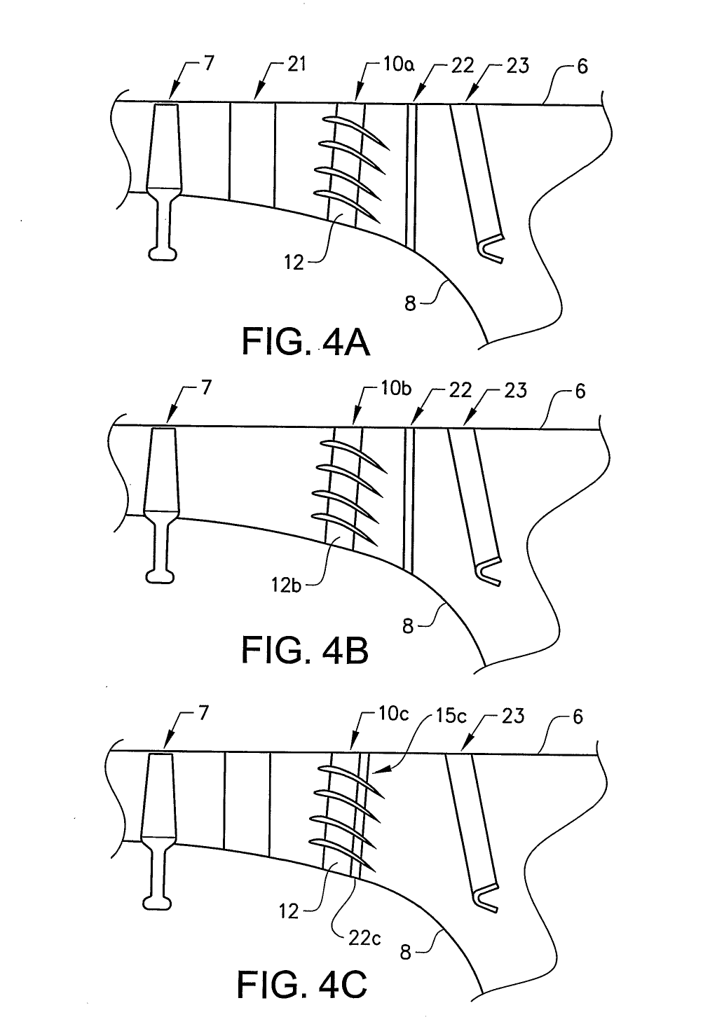

FIG. 2 shows a schematic rear view of the masking arrangement 10 indicated in FIG. 1. The upper half 10a of FIG. 2 shows a rear view of a plurality of annular elements (vanes) 11 which are arranged overlapping one another when viewed in an axial direction, while the lower half 10b of FIG. 2 shows a cross-section in a radial plane through the circular vanes 11 in a section A-A indicated in FIG. 3. Hence, the upper half of FIG. 2 shows the overlapping, circular vanes 11 in the position where any hot or rotating components located upstream of the masking arrangement are masked from view. The lower half of the figure shows an example where both the circular vanes 11 and the radial supports 12 are hollow. This feature will be described in further detail below.

FIG. 3 shows a cross-section through the circular vanes 11 parallel to a radial support, as indicated by section B-B. As can be seen in the figure, the circular vanes 11 have a cross-section shaped as an airfoil 13. The airfoil shape assists the masking arrangement in controlling the flow over the centre cone and in a diffusive exhaust nozzle. Both the shape and angle of the annular vanes can be used for separation control, especially for controlling the flow over the centre cone, which improves the engine performance and acoustics. The annular vanes can be used for flow control by adjusting the direction and distribution of flow in a diffuser before flame holder. This is used for stabilizing the flow by adjusting the exhaust flow to provide optimal flow characteristics for fuel injection and flame stabilization in the afterburner arrangement.

As indicated by FIGS. 2 and 3, the radial supports 12 in this example comprise elongated profiles with parallel sides, which sides are placed parallel to the direction of flow of the exhaust gas. The radial supports 12 further comprise leading and trailing edges 14, 15 which can be rounded or come to a point at the substantially radially extending front and rear edges of the said radial supports 12. In this example the radial supports 12 are also shown as being inclined at comparatively small angle α rearwards relative to a plane at right angles to the longitudinal axis of the engine. The angle α is preferably selected in the range 0-5°. However, the angle of the radial supports may be selected in the range from −45° to +45°. The example of FIGS. 2 and 3 shows a masking arrangement provided with 4 circular vanes and 8 radial supports. However, the number of vanes and supports can be selected freely depending on the size of the engine and the function or functions to be performed by the respective component. In the above figures, the circular vanes are shown as being substantially equidistant relative to each other and all vanes have the same airfoil shape and are placed at the same angle relative to the radial support. Within the scope of the invention, the relative distance between adjacent vanes and supports, as well as the size, shape and angle of each respective airfoil and support, may each be individually selected to adapt the masking arrangement to any type of gas turbine engine.

As described above there may be a number of components between the final stage of the turbine and the exhaust exit port. This is particular the case in a military jet engine that must be able to perform different tasks. An exhaust section can be provided with three main components, that is, a de-swirling device, a fuel injection system, and a flame holder, where the latter two components form part of an afterburner arrangement. The axial extent of the exhaust casing nozzle must be adapted to be sufficiently long to support all these components. At the same time it is desirable to keep the engines as short as possible to save weight and thereby fuel consumption.

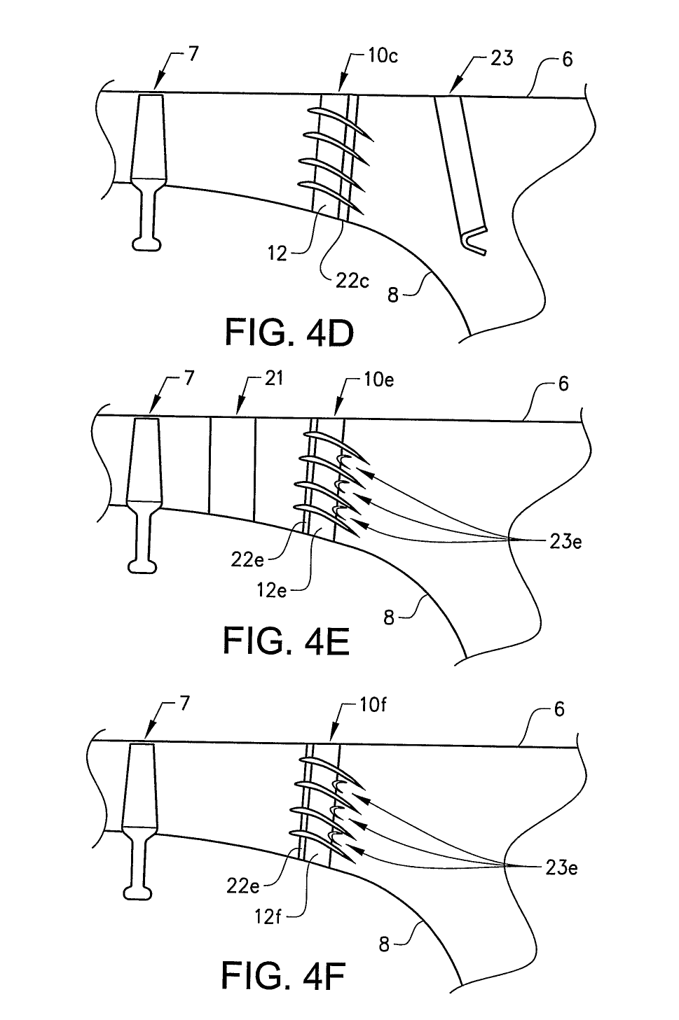

FIG. 4A shows an exhaust section 20 according to a first alternative example of the invention. In the direction of flow of exhaust gas, the exhaust section 20 comprises a de-swirling device 21, a fuel injection system 22, and a flame holder 23. As described above, the de-swirling device 21 is a radial vane with an airfoil cross-section arranged to correct the swirling motion of the exhaust gas flow as it leaves a final stage 7 of the turbine section T (see FIG. 1). In this example, a masking arrangement 10a as shown in FIGS. 2 and 3 is located between the de-swirling device 21 and the fuel injection system 22. In this example the masking arrangement is mainly intended for reducing the IR and radar signature of the engine.

FIG. 4B shows an exhaust section 20 according to a second alternative example of the invention. In the direction of flow of exhaust gas, the exhaust section 20 comprises a fuel injection system 22, and a flame holder 23. According this example, a modified masking arrangement 10b with radial supports 12b are arranged as de-swirling vanes downstream of the final turbine stage 7. In order to achieve this, the radial supports 12b are rotated a predetermined angle about their respective longitudinal axis, so that they are mounted at a suitable angle relative to the direction of flow. More preferably, the radial supports 12b are provided with an airfoil cross-section having the same shape as the de-swirling device that it is replacing. In this way the radial supports 12b can be used for correcting the swirling flow of the exhaust after leaving the final turbine stage.

FIG. 4C shows an exhaust section 20 according to a third alternative example of the invention. In the direction of flow of exhaust gas, the exhaust section 20 comprises a de-swirling device 21, a fuel injection system 22c, and a flame holder 23. According to this example, a modified masking arrangement 10c with radial supports 12c are provided with fuel injection nozzles 22c along the trailing edge 15c of the radial supports 12c. The fuel injection nozzles 22c are arranged as a fuel injector system for an afterburner arrangement. A fuel conduit (not shown) extends from a radially outer end of the radial support 12c through a separate conduit or a suitable hollow section in the radial support 12c to exit at a predetermined number of radially spaced fuel injection nozzles (not shown) along a rear section of said support. Alternatively, the fuel injection nozzles may be arranged at the leading or trailing edge of the annular elements.

This third alternative example can be modified by combining it with the second alternative example, using the radial supports 12b of FIG. 4B to replace the de-swirling vanes downstream of a final turbine stage, as shown in FIG. 4D. In addition, the radial supports 12b are provided with the fuel injection nozzles 22c shown in FIG. 4C.

FIG. 4E shows an exhaust section 20 according to a fourth alternative example of the invention. In the direction of flow of exhaust gas the exhaust section 20 comprises a de-swirling device 21 upstream of radial supports 12e. According to this example, a fuel injection system comprising fuel spray bars 22e are arranged between each radial support 12e and a flame holder 23e for the afterburner arrangement has been integrated in the trailing edges of the radial supports 12e.

This fourth alternative example can be modified by combining it with the second alternative example, using the radial supports 12b of FIG. 4B to replace the de-swirling vanes downstream of a final turbine stage, as shown in FIG. 4F. In addition, the spaces between the radial supports 12b are provided with the fuel spray bars 22e shown in FIG. 4E.

Although not visible in FIGS. 4E-4F, the fuel injection nozzles can also be placed in the leading edge or in a flow controlling surface of the radial supports provided with an airfoil cross-section, while the flame holder may be attached to or integrated in trailing section thereof.

FIGS. 4A-4F indicate that by co-locating or combining components relating to flow control and/or the afterburner arrangement with the masking arrangement, it is possible to shorten one or more of the exhaust shroud 5, exhaust nozzle 6 and/or central cone 8 is possible.

According to a further example, the circular vanes 11 and the radial supports 12 are provided with cooling channels 24, 25 for reducing the temperature of the masking arrangement 10, as schematically illustrated in FIGS. 2 and 3. The cooling channels may comprise separate conduits or may use existing internal hollow sections 25 through at least the radial supports 12. Alternatively, the cooling channels 24 may extend in similar conduits or existing internal hollow sections through the circular vanes 11 to further reduce the temperature of the masking arrangement 10. The coolant used for this purpose can be taken from an existing source of coolant for the gas turbine engine. Alternatively, fuel supplied to the injection nozzles in the afterburner arrangement is used for cooling purposes, at least for cooling the radial supports. The method of cooling and the type of coolant used is dependent on the component parts present in each of the examples described in FIGS. 4A-4F above.

The invention is not limited to the examples described above, but may be varied freely within the scope of the appended claims. For instance, although the above examples describe a masking arrangement comprising annular elements in the form of circular vanes, the invention is limited neither to circular elements, nor to elements in the form of vanes.

1. A masking arrangement for a gas turbine engine, wherein the masking arrangement is configured to be attached between an outer wall and an inner wall defining an exhaust gas flow in the gas turbine engine, and the masking arrangement comprises at least one annular element, which is adapted to mask at least a substantial portion of an interior gas turbine engine part at an aft end of the gas turbine engine from rear view when the masking arrangement is applied downstream the interior part in the gas turbine engine.

2. An arrangement according to claim 1, wherein the masking arrangement comprises a plurality of annular elements arranged overlapping one another when these are viewed in an axial direction so as to mask the at least substantial portion of the interior gas turbine engine part at the aft end of the gas turbine engine from rear view when the masking arrangement is applied downstream the interior part in the gas turbine engine.

3. An arrangement according to claim 1, wherein the annular element form a vane.

4. An arrangement according to claim 1, wherein the annular element has a cross-section in the shape of an airfoil.

5. An arrangement according to claim 1, wherein the annular element has a circular shape.

6. An arrangement according to claim 1, wherein there are at least two annular elements and at least two of the annular elements are at least partially axially displaced relative to one another.

7. An arrangement according to claim 1, wherein the annular element is arranged to be angled relative to an axial direction of the arrangement.

8. An arrangement according to claim 1, wherein the annular element is arranged to be angled towards a central axis to the rear of the masking arrangement.

9. An arrangement according to claim 1, wherein the masking arrangement comprises at least one support for attachment of the annular element.

10. An arrangement according to claim 9, wherein a plurality of the supports are arranged circumferentially spaced.

11. An arrangement according to claim 9, wherein the support extend in a substantially radial direction of the arrangement.

12. An arrangement according to claim 8, wherein the support is arranged as a de-swirling vane downstream of a final turbine stage.

13. An arrangement according to claim 1, wherein the arrangement is adapted with fuel injection nozzles arranged as a fuel injector system for an afterburner arrangement.

14. An arrangement according to claim 1, wherein the arrangement is adapted for a flame holder for an afterburner arrangement.

15. An arrangement according to claim 1, wherein the arrangement is adapted for an air injection/mixing device.

16. An arrangement according to claim 1, wherein the arrangement is adapted for controlling a flow over a center cone and/or in a diffusive exhaust nozzle,

17. An arrangement according to claim 1, wherein the arrangement is provided with cooling channels for reducing the temperature of the masking arrangement,

18. An arrangement according to claim 1, wherein at least the annular elements are coated with a radar absorbing material.

19. A gas turbine engine provided with a masking arrangement according to claim 1, wherein the masking arrangement is positioned downstream of a last rotating stage of a turbine.
